(19) United States
(12) Patent Application Publication
(10) Pub. No.: US 2026/0350590 A1
(43) Pub. Date: Nov. 5, 2026

(54) UNIFIED USER AUTHENTICATION AND BLOCKCHAIN CONNECTION

(71) Applicant: Via Science, Inc., Somerville, MA (US)

(72) Inventors: Jesus Alejandro Cardenes Cabre, Montreal (CA); Madjid Aoudia, Rennes (FR)

(21) Appl. No.: 19/666,503

(22) Filed: May 4, 2026

Related U.S. Application Data
(60) Provisional application No. 63/799,974, filed on May 5, 2025.

(51) Int. Cl. G06Q 20/36; G06Q 20/02; G06Q 20/38

(52) U.S. Cl. CPC G06Q 20/3674; G06Q 20/02; G06Q 20/3825

(57) ABSTRACT

A system may be configured to unify the processes for authenticating a user to access an application and establishing a connection to a blockchain network. By unifying these processes, the system can reduce the friction of separate authentication and blockchain connection workflows, particularly for users who are unfamiliar with blockchain concepts such as selecting a wallet provider, managing cryptographic keys, approving connection requests, and digitally signing messages. The system may leverage a user-controlled trust data wallet (e.g., a digital wallet application) on their mobile device. The digital wallet may facilitate obtaining and storing verifiable credentials from a trusted issuer, authenticating the user with the application, establishing a blockchain connection, and approving blockchain transactions (e.g., initiated with or by the application).

### CROSS-REFERENCE TO RELATED APPLICATION

This application claims the benefit of priority of U.S. Provisional Patent Application No. 63/799,974, filed May 5, 2025, and entitled “SYSTEM AND METHOD FOR UNIFIED USER AUTHENTICATION AND BLOCKCHAIN CONNECTION,” the content of which is incorporated herein by reference in its entirety.

### BRIEF DESCRIPTION OF DRAWINGS

For a more complete understanding of the present disclosure, reference is now made to the following description taken in conjunction with the accompanying drawings.

FIG. 1A is a conceptual diagram illustrating the integration of user authentication and blockchain connection, according to embodiments of the present disclosure.

FIG. 1B illustrates certain components and operations of the system in further detail, according to embodiments of the present disclosure.

FIGS. 2A and 2B are signal flow diagrams illustrating an example registration process, according to embodiments of the present disclosure.

FIGS. 3A through 3C are signal flow diagrams illustrating an example login flow including authenticating a user and creating a blockchain connection, according to embodiments of the present disclosure.

FIG. 4 is a conceptual diagram illustrating an example method of facilitating user authentication and blockchain connection, according to embodiments of the present disclosure.

FIG. 5 is a conceptual diagram illustrating an example method of obtaining user authentication and blockchain connection, according to embodiments of the present disclosure.

FIG. 6 illustrates a device and system component communicating over a computer network, according to embodiments of the present disclosure.

### DETAILED DESCRIPTION

The Internet and other computer network technologies allow users to access resources hosted by computer systems both locally and over large geographic distances. The resources may include websites, applications, databases, etc. Some resources may be available for anyone with a browser to locate, visit, and use. Some resources may require a user to identify themselves and/or sign in using a password or passkey. A system hosting the resource may check the password or passkey against its database to see if it is valid and current.

Systems such as these may be referred to as hosting Web2 resources, such as websites and/or applications that rely on centralized management of passwords and tokens. For example, a central database may maintain information regarding user accounts including their corresponding passwords/passkeys. To promote convenience, the system may provide an authenticated user (e.g., one whose identity or password has been verified) with a token that allows the user to maintain a session of continued access to the system for a limited time before the user has to validate themselves again. The token may be a long number or string of characters similar to a password that the user/user device shares with the application when sending requests to the system over the course of the session. Because the user and the system exchange the token repeatedly, however, they face risk of another entity intercepting the token and using it for nefarious purposes.

In contrast, Web3 resources differ in the manner in which a user imports their identity into the system. While Web2 resources use centralized identity management, Web3 uses decentralized credentialing based on decentralized, asymmetric cryptographic credentials such as decentralized identifiers (DIDs) and verifiable credentials (VCs). A DID is an identifier that allows a user to be identified in a verifiable and persistent manner within the system in which users are registered, but without the need for a centralized registry. The DID consists of a cryptographic key pair with a private key stored securely by the user (e.g., in a digital wallet application as described below) and a corresponding public key that can be recorded in a distributed ledger (e.g., a blockchain), which may store an immutable record of the public key and attributes associated with it. The user may prove their identity by signing a document with their DID private key, and a verifier may verify the user's identity using the corresponding public key.

A VC has an issuer and a holder (e.g., the user). The VC represents a document, cryptographically signed by the issuer, that associates or assigns one or more attributes to the user (e.g., the user's DID public key). A verifier may use the issuer's public key (e.g., corresponding to the issuer's private key used to cryptographically sign the VC) to verify that the user has the attributes. Thus, if the issuer is trusted, the user presenting a VC from the issuer can be trusted to have the attributes represented in the VC.

A user may use their DID and/or VC(s) to establish their identity and/or attributes when interacting with Web3 resources such as decentralized applications (or “dApps,” described further below). Importantly, the user maintains sole control over the information in their DID and VC(s), in contrast to Web2 authentication methods that rely on the transmission of, for example, emails and passwords.

In some cases, a dApp or other enterprise application may be associated with a blockchain. The enterprise application may use the blockchain to record data, maintain cryptocurrency accounts and facilitate cryptocurrency transactions, maintain and execute smart contracts, and so on. To interact with the blockchain, however, the user establishes a connection to the blockchain network that may be separate from the connection to the enterprise application.

Offered herein are techniques for unifying the processes for authenticating a user for accessing an enterprise application and establishing a connection to a blockchain network. By unifying these processes, these techniques can reduce the friction of separate authentication and blockchain connection workflows, particularly for users who are unfamiliar with blockchain concepts such as selecting a wallet provider, managing cryptographic keys, approving connection requests, and digitally signing messages. The techniques leverage a user-controlled trust data wallet (e.g., a digital wallet application) on the user's mobile device. The digital wallet may facilitate obtaining and storing VCs from a trusted issuer, authenticating the user with an enterprise application, establishing a blockchain connection, and approving blockchain transactions.

In an example operation, a user may request access to a resource such as an enterprise application. The resource may initiate an authentication flow in which the user can perform a single action with their digital wallet to trigger presentation of the user's credential and establishing a blockchain connection. For example, the resource may redirect the user's client device to a webpage that may display a quick-response (QR) code that the user may scan using the digital wallet executing on their mobile device. By scanning the QR code, the user may trigger the digital wallet to present a verifiable presentation (VP) of the user's VC to an authentication system for verification, and establish a connection with the blockchain network.

Upon verification of the VP, the system may grant the user access to the enterprise application and establish a ready-to-use connection to the blockchain pipeline. The unified approach abstracts the complexity of blockchain connectivity from the user, making it appear as a seamless part of the standard login process. Thus, the system can significantly reduce friction, improve the usability of applications requiring blockchain interaction, and facilitate secure, decentralized authentication and authorization. The system can be configured to handle users who are pre-registered in the authentication system as well as new users registering to obtain VCs.

These features may be used alone or in combination with each other and/or other features described herein. Various operations of the systems and devices may be subject to user approval. The system may be implemented in a manner that ensures compliance with applicable laws, regulations, standards, etc., in the region(s) where the user, devices, and/or systems are located.

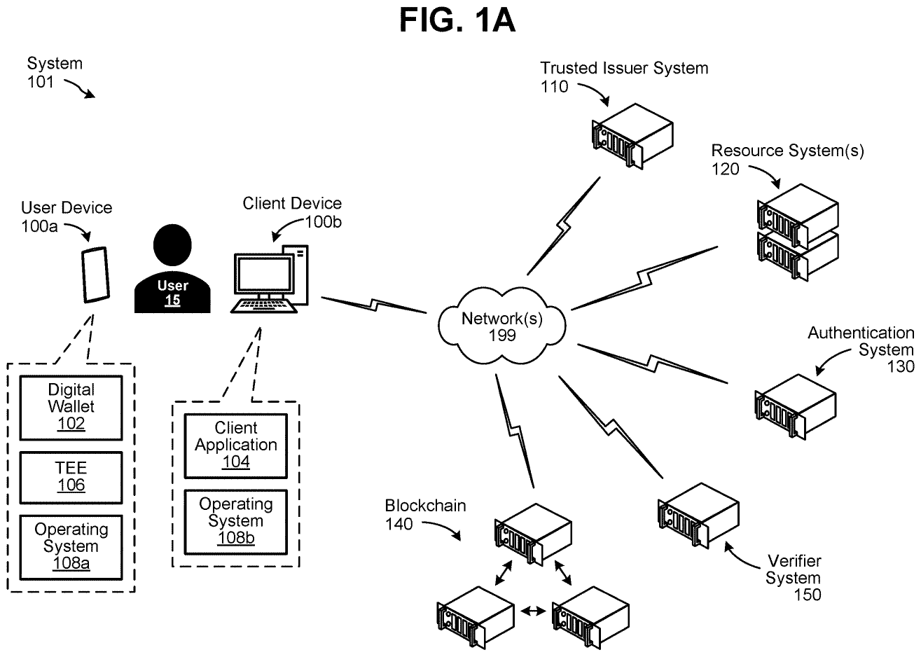

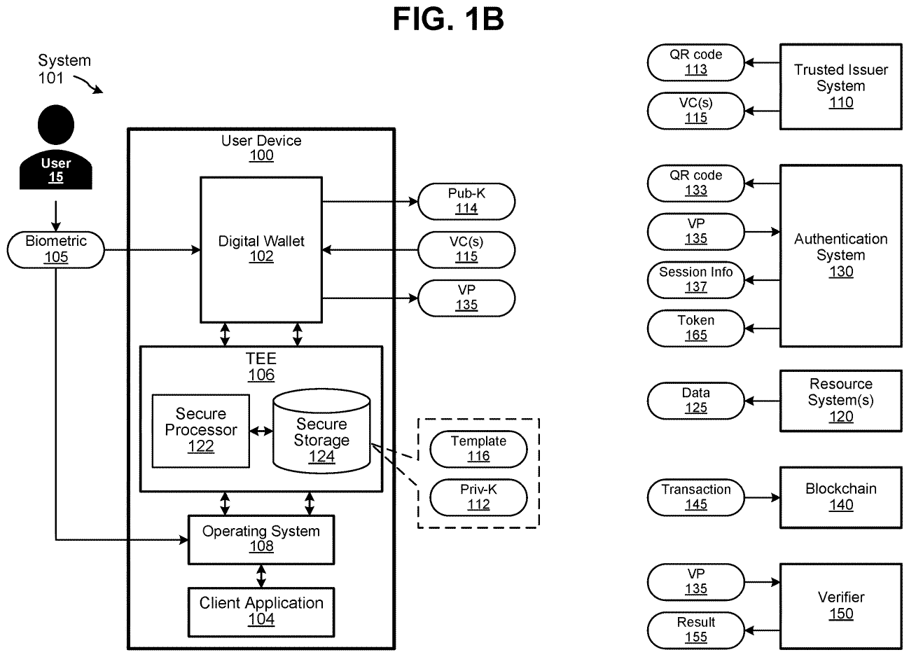

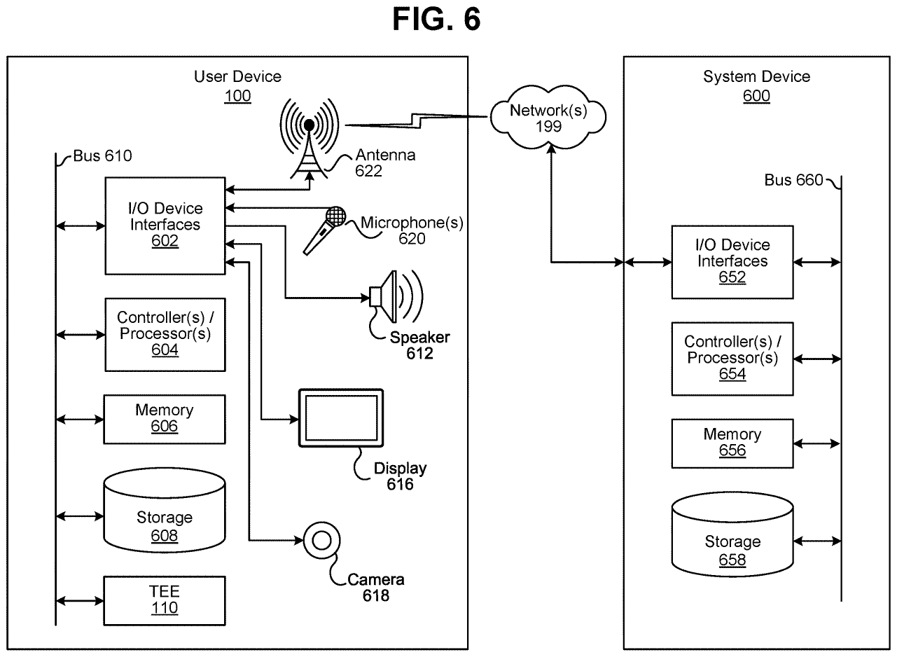

FIG. 1A is a conceptual diagram illustrating the integration of user authentication and blockchain connection, according to embodiments of the present disclosure. A user 15 may interact with one or more user devices 100 such as a mobile device 100a (e.g., a mobile phone) and/or a client device 100b (e.g., a laptop, tablet, or desktop computer, etc.). For example, the user device 100a may host the digital wallet application (“digital wallet 102”) used to maintain VCs and cryptographic keys, scan requests (e.g., QR codes), generate VPs, and digitally sign messages. The user device 100b may host a client application 104 used to interact with a resource such as an enterprise application hosted by one or more resource systems 120. When operating in or with a system 101, the user device(s) 100 may exchange data across one or more computer networks 199 with other user devices 100 and/or various system devices such as the one or more resource system(s) 120, a trusted issuer system 110, an authentication system 130, a blockchain 140 and/or other distributed ledger technology, and/or a verifier system 150, etc. Accordingly, operations attributed herein to the system 101 may be performed by a single device or by two or more devices interacting with each other. Example hardware components of a user device 100 and a system device 600 are described in further detail below with reference to FIG. 6. The system 101 may include more or fewer components without departing from the scope of this disclosure.

The user device(s) 100 may include an operating system (OS) 108. The OS 108 manages the hardware and software resources of the user device 100, provides the user 15 with configurable settings for the function and use of the user device 100, and provides various services for other software (e.g., apps) running on the user device 100. The OS 108 may allow the user to enroll a biometric ID, personal identification number (PIN), password, and/or configure other settings of the user device 100. Examples of common operating systems for personal electronic device include Android, developed by the Open Handset Alliance, and iOS, developed by Apple Inc of Cupertino, CA. In some cases, the user devices 100a and 100b may use the same OS 108. In some cases, the first user device 100a may use a first OS 108a and the second user device 100b may use a second OS 108b different from the first.

One or more of the user devices 100 may include a trusted execution environment (TEE) 106. A TEE is a separate and secure processor, or area of the main processor, of a personal electronic device. In some cases, a TEE may have dedicated memory and/or storage protected by hardware-based encryption. A TEE protects the integrity and confidentiality of code and data loaded into the TEE. Code and data loaded into the TEE cannot be read, modified, or replaced by unauthorized entities. TEEs can be further hardened against duplication or simulation using a hardware root of trust such as embedding private keys directly into the silicon during manufacturing such that the keys cannot be changed by software means. Examples of TEEs are Secure Enclave offered by Apple Inc of Cupertino, CA, and Trust offered by Google LLC of Mountain View, CA.

The user device(s) 100 may include a digital wallet application (e.g., digital wallet 102), also referred to as a trust data wallet, and a client application 104. In some cases, the digital wallet 102 and the client application 104 may be on the same user device 100. In some cases, the digital wallet 102 may be on the first user device 100a while the client application 104 may be on the second user device 100b. The digital wallet 102 and/or the client application 104 may be software components stored in a memory of the user device 100 and executing on a processor (or processors) of the user device 100. A digital wallet application is a software component such as an app that executes on the processor or processors of a personal electronic device. In some cases, a digital wallet application may be capable of performing certain limited operations using the device's TEE 106. For example, the digital wallet application may allow the user to generate cryptographic keys in the TEE 106, and use the TEE to sign VCs using the cryptographic keys to generate VPs, subject to policies and permissions dictated by the VCs and/or enforced by the TEE. For example, the TEE 106 may require the user to authenticate themselves prior to using a cryptographic key stored in the TEE. An example of a digital wallet application is the VIA Wallet developed by VIA Science, Inc. of Somerville, MA.

The digital wallet 102 may obtain and store a VC obtained from the trusted issuer system 110. The trusted issuer system 110 may represent, for example, a certificate authority, an organization such as a government or an NGO, and/or an identity provider (IdP) such as Okta, Inc. of San Francisco, CA or the Google customer identity and access management (CIAM) platform. In some implementations, the trusted issuer system 110 may be part of an organization associated with the resources the user 15 wishes to access. Entities such as the resource system 120 and/or the authentication system 130 may outsource user authentication to the trusted issuer system 110. Thus, once the user 15 establishes their identity with the trusted issuer system 110 and receives the VC, the user 15 may use the VC to authenticate themselves with various relying parties. Thus, in some cases, the trusted issuer system 110 can allow for a user 15 to user single sign-on (SSO) to access various resource systems 120.

A VC is a digital document (e.g., a digital credential) that contains information corresponding to the holder, such as an identity or attribute. The information can represent a tangible credential such as a government-issued identification or an intangible attribute such as bank account. VCs operate in a triangle of trust between three parties: a trusted issuer, a holder, and a verifier. The holder may obtain a VC from the issuer and use the VC to prove a fact to the verifier; for example, the holder's identity, age, employment, etc. In the triangle of trust the issuer trusts the holder, the holder trusts the verifier, and the verifier trusts the issuer.

The use of VCs relies on cryptographic techniques such as digital signatures to make the VCs resistant to tampering or copying. For example, the trusted issuer may digitally sign a VC with their private key so that other parties can verify the provenance of the VC using the trusted issuer's public key. Similarly, the holder may digitally sign the VC using their own private key to generate a verifiable presentation (VP) for presentation to a verifier. If the holder's corresponding public key is in the VC, which has been signed by the trusted issuer, the holder can use the VP to prove to a verifier that the holder has established their identity/attributes with the trusted issuer. In other words, the verifier may use the trusted issuer's public key to verify that the trusted issuer signed the VC, and the public key in the VC to verify that the party who signed the VP is the proper holder of the VC. Typically, the trusted issuer system 110 will issue the VC to the user's personal electronic device; i.e., the user device 100a. The user 15 may store the VC in the device, and use the TEE 106 to apply a digital signature to the VC to generate a VP.

The user 15 may use their digital wallet 102 to authenticate themselves with the authentication system 130 so that the user 15 can access the resource system(s) 120 using their client application 104. The client application 104 may be, for example, an application such as a browser executing on the user device 100. The user 15 may use the client application 104 to request access to a resource hosted by the resource system 120. The client application 104 may be prompted to register and/or log in to access the resource. Following registration/login, a session (e.g., an OpenID Connect (OIDC) session) is established with the client, allowing it to access the resource. The client application 104 may receive an authentication token for the session. The authentication token may allow the client application 104 to continue accessing the resource system(s) 120 for a period of time without having to reauthenticate themselves.

The authentication system 130 is a system that can authenticate user identity and authorize access to online resources (e.g., apps and other resources hosted by the resource system 120). The authentication system 130 may perform various functions including simplifying user access to applications with single sign-on (SSO), managing passwords and access control for resource systems 120, and providing enhanced security via multi-factor authentication (MFA), etc. In some implementations, the authentication system 130 may leverage protocols such as OIDC. In some implementations, the authentication system 130 may be implemented using software such as Keycloak.

The authentication system 130 may manage aspects of the registration and login processes. A user 15 may be redirected to the authentication system 130 when requesting access to a resource hosted by a resource system 120. During a registration process, the authentication system 130 may obtain user attributes such as their DID, domain of the trusted issuer system 110, and/or attributes provided by the trusted issuer system 110. The attributes may include, for example, the user's role(s) within the organization (e.g., title, rank, position, and/or responsibilities), group membership(s), email address and/or username, etc. The authentication system 130 may direct the user 15 to the trusted issuer system 110 to obtain a VC. When the trusted issuer system 110 notifies the authentication system 130 that registration is complete, the authentication system 130 can send the client application 104 an authentication token 165 and redirect it to the resource system 120 hosting the requested resource.

In some implementations, the authentication system 130 may include a verifier component for verifying VPs presented by the digital wallet 102. In some implementations, however, the system 101 may include a separate verifier system 150 that can verify VPs. In some cases, the verifier system 150 can receive a VP from a digital wallet 102, and send a verification result to the authentication system 130. In some cases, the authentication system 130 may receive a VP from a digital wallet 102 and forward the VP to the verifier system 150 for verification.

A resource system 120 may host one or more Web2 and/or Web3 resources such as a web app (e.g., application software created with web technologies and run via a web browser), dApp, website or service requiring authorization, distributed ledger such as a blockchain, etc. In some cases, the resource system 120 may be referred to as an app host, enterprise system, etc. In some implementations, the user 15 may authorize a resource hosted by the resource system(s) 120 to interact with the blockchain 140 on the user's behalf.

A blockchain such as the blockchain 140 may be a distributed ledger system made up of a plurality of distributed nodes that form a shared, replicated, synchronized data store. A blockchain may store data such as a transactions and smart contracts. A smart contract is a digital contract that executes automatically when predetermined terms and/or conditions are met. Decentralized applications (dApps) may have a back end that includes a smart contract stored on a blockchain and a front end that can be a traditional web app. A dApp can have additional decentralized/distributed components when its code and/or database(s) need to be modifiable (e.g., unlike the contents of a blockchain, which are immutable) and/or when the code and/or database(s) grow larger than what can be practically stored on the blockchain. A user 15 may establish their identity with a dApp using their DID and/or authenticate themselves with dApp using their VC.

The nodes of a distributed ledger may execute a consensus algorithm to determine the correct updated ledger to represent the addition of new data (e.g., following receiving data from an authenticated user 15). The distributed nodes may form a peer-to-peer network (e.g., within and/or across the computer network 199) to propagate updates once the correct updated ledger is determined. Each distributed node may then update itself accordingly. The result is a tamper resistant (e.g., immutable or substantially immutable) record of the received data replicated across multiple nodes and without a single point of failure.

The distributed ledger may be a linear data structure (e.g., a chain such as blockchain) or a more complex structure like a directed acyclic graph. A directed acyclic graph in the context of a distributed ledger may be made up of blocks of data and edges indicating adjacency of data blocks added to the distributed ledger. Each edge is directed, indicating a direction from an existing data block to a new data added to the existing data block. The structure is acyclic in that it contains no paths by which a data block can be crossed twice by traversing any sequence of edges according to their direction (e.g., no edges are directed “backwards” in time). A data block may, however, have multiple edges directed to it and/or away from it.

The consensus algorithm may be a proof-of-work algorithm or a proof-of-stake algorithm. A proof-of-work algorithm is a form of cryptographic proof an entity can use to prove to others that it has performed a certain about of computational work. The proof is asymmetric in that a verifier may confirm the proof with minimal computational effort. An example of proof-of-work in the context of distributed ledgers is “mining” for cryptocurrency, where mining refers to the incentive structure used to encourage nodes to expend computational effort to add data blocks to the distributed ledger. In contrast, proof-of-stake protocols only allow nodes owning some quantity of data blocks (e.g., blockchain tokens) to validate and add new data blocks. Proof-of-stake protocols prevent attackers from hijacking validation by requiring an attacker to acquire a large proportion of data blocks. Proof-of-stake protocols include, for example, committee-based proof of stake, delegated proof of stake, liquid proof of stake, etc.

Distributed ledgers may be permissioned or permissionless. A permissioned distributed ledger may refer to a private system having a central authority for authorizing nodes to add data blocks. In some cases, a consortium may agree to operate a distributed ledger jointly among the participating organizations while excluding others. A permissionless distributed ledger may refer to an open or public network for which no access control is used. Any entity may add to the distributed ledger, provided they satisfy the consensus algorithm (e.g., proof of work). An example of a permissionless distributed ledger is bitcoin and other cryptocurrencies that require new entries include a proof of work. In some implementations, the distributed nodes may be open (e.g., viewable by the public) to allow observers to see data recorded on the blockchain.

In an example interaction flow, the user 15 may wish to use their client device 100b to interact with an enterprise application such as a dApp hosted by the resource system(s) 120. The client device 100b may include a client application 104 such as a web browser that the user 15 may use to navigate to the resource. In some cases, the client application 104 may be an application dedicated to interaction with the specific resource. In any case, if the user does not currently have a VC for authenticating with the resource, the landing page may redirect the user to a sign-up page hosted by the authentication system 130.

The user 15 may initiate registration by providing minimal information such as an email address to the authentication system 130. Upon verifying the email address, the authentication system 130 may send the user an email with a one-time verification code (e.g., a PIN). The user 15 may enter the code into the sign-up page. Upon verifying the code, the authentication system 130 may redirect the client application 104 to an endpoint hosted by the trusted issuer system 110. Alternatively, the email may contain a verification uniform resource locator (URL) that may redirect the client application 104 to the endpoint. The trusted issuer system 110 may present a QR code to the client application 104. The user 15 may use the digital wallet 102 of their mobile device 100a to scan (e.g., using a camera of the mobile device 100a) the QR code displayed by the client device 100b. The digital wallet 102 may use the information in the QR code to establish a connection with the trusted issuer system 110. The connection may be, for example, a wallet connect session, which is a type of a WebSocket connection that will allow bidirectional communication between the digital wallet 102 and the trusted issuer system 110 over a Transmission Control Protocol (TCP) connection.

The digital wallet 102 may send the request for a VC to the trusted issuer system 110 via the wallet connect session. If the trusted issuer system 110 determines that the user 15 of the digital wallet 102 is entitled to a VC, the trusted issuer system 110 may create the VC and return it to the digital wallet 102 via the wallet connect session. The digital wallet 102 may store the VC on the user device 100a.

The VC may indicate an attribute of the holder such as identity, age, rank, title, association with various entities, etc. In some cases, the VC may include a public key corresponding to a private key held by the digital wallet 102. The trusted issuer system 110 may sign the VC using its own private key. Thus, an observer (e.g., a verifier system) can use the public key of the trusted issuer system 110 to verify that a digital signature corresponds to the user's public key in the VC. For example, if the user 15 uses their digital wallet 102 to generate a VP by digitally signing the VC using the private key corresponding to the public key in the VC, and the observer trusts the trusted issuer system 110 who signed the VC, the observer can surmise that the offeror of the VP is who they say they are.

Once the trusted issuer system 110 has verified the user 15 and provided the VC, the trusted issuer system 110 may notify the authentication system 130 that registration is complete. Upon receiving the notification, the authentication system 130 may redirect the user's client application 104 back to the resource.

Once the user 15 has a valid VC, upon requesting access to the resource, the resource system(s) 120 may redirect the client application 104 to the authentication system 130, which may present a QR code containing session information linked to the user's authentication request. The user 15 may scan the QR code using the digital wallet 102. The digital wallet 102 may use the information in the QR code to create a wallet connect session. In some cases, the QR code may additionally include a VP request. In some cases, the digital wallet 102 may use the wallet connect session to obtain the VP request. The digital wallet 102 may evaluate the VP request and prompt the user 15 for approval to present their VCs. Upon user approval, the digital wallet 102 may generate a VP and send it to the authentication system 130 (or, in some cases, the verifier system 150). If the authentication system 130 or verifier system 150 successfully verifies the VP, the authentication system 130 may authenticate the client applications 104 OIDC session and redirect the client application 104 back to the resource with authenticated access. The authentication system 130 may temporarily store session information about the wallet connect session for future use in executing blockchain transactions. Once the client application 104 is redirected back to the resource, the client application 104 may retrieve the session information from the authentication system 130 for use in interactions with the resource. Then, either the client application 104 or the resource may use the session information to recover the blockchain session for executing transactions on the blockchain 140.

FIG. 1B illustrates certain components and operations of the system 101 in further detail, according to embodiments of the present disclosure. The user device 100 may include the digital wallet 102, the TEE 106, and the OS 108 as previously described. The digital wallet 102 and the OS 108 may include computer code stored in the memory of the user device 100 and executing on the processor(s) of the user device 100. In various use cases, the user device 100 may execute various apps in addition to the digital wallet 102; for example, the user device 100 may include various phone and or messaging apps, email clients, web browsers, resource-specific apps (e.g., corresponding to a particular bank, airline, store, etc.), games, and so on.

The TEE 106 may include hardware components such as a secure processor 122 and/or a secure storage 124. The secure processor 122 may be a separate processor, or separate area of the main controller(s)/processor(s) 604 of the user device 100. The secure processor 122 may include architectural protections (e.g., built into the hardware) that allow it to perform certain, predefined functions that prevent interference from software executing on the main controller(s)/processor(s) 604. The TEE 106 may include a secure storage 124, which may be protected by hardware-based encryption to prevent reading and tampering of the software and data stored thereon. The TEE 106 may include further features to prevent other devices from attempting to “impersonate” the user device 100 by duplicating or simulating the TEE 106. For example, in some implementations, the TEE 106 may include one or more private keys embedded directly into the secure processor 122 and/or main processor of the user device 100 during manufacturing (e.g., using a one-time programmable memory such as an eFuse). Hard-coded private keys such as these may create a “hardware root of trust” that prevents simulation of the TEE 106 and its private keys by software means. In some implementations, a VC 115 may be tied to one of these embedded cryptographic keys, such that the VC may only be accepted if it includes a public key (digitally signed by the trusted issuer system 110) corresponding to the embedded private key.

The digital wallet 102 may also include security features to prevent unwanted access by individuals other than the user 15. For example, the digital wallet 102 may be protected by a PIN, password, and/or a biometric lock. The biometric lock may require the user 15 to provide a biometric ID to open and use the digital wallet 102. The biometric ID may be, for example, a fingerprint, iris scan, face scan, etc. The user 15 may provide a biometric input 105, which the digital wallet 102 may use to create a biometric template 116. When the user 15 subsequently attempts to open and use the digital wallet 102, the digital wallet 102 may prompt the user 15 for their biometric ID. The user 15 may enter a biometric input 105, and the digital wallet 102 may compare the biometric input to the previously created biometric template 116. If the digital wallet 102 determines that the biometric input 105 matches the biometric template 116 within a threshold level of confidence, the digital wallet 102 may allow the requested use.

The digital wallet 102 may use the TEE 106 to store data and perform certain operations. The digital wallet 102 may use the TEE 106 to generate cryptographic key pairs and securely store the private keys. A cryptographic key pair may include a private key (Priv-K 112) and a public key (Pub-K 114). Cryptographic key pairs may be used to, for example, establish a decentralized identifier (DID) for the user 15, register a passkey for accessing a resource system, digitally sign documents, etc. The digital wallet 102 may use the TEE 106 to store VCs 115 received from the trusted issuer system 110, and use the VCs 115 to generate VPs 135. The digital wallet 102 may also use the TEE 106 to generate, store, and match biometric templates 116 to biometric inputs 105.

The TEE 106 may enforce policies on access to data stored in the secure storage 124 and/or on executing operations using the secure processor 122. For example, the TEE 106 may only make a set of limited, predefined functions available to the digital wallet 102 and other software executing on the device. Moreover, the TEE 106 may require a heightened level of authentication for the use of certain data and/or operations. For example, the TEE 106 may allow use of a first cryptographic key when the user device 100 is unlocked (e.g., with a simple “swipe” confirmation), require the user's PIN for use of a second cryptographic key, and forbid use of a third cryptographic key unless the user 15 authenticates themselves with a valid biometric ID. For example, the TEE 106 may link a cryptographic key and a certain biometric template 116. A linked cryptographic key increases security because if the user 15 replaces their biometric template 116 with a new biometric ID (e.g., rescanning their fingerprint, or changing from fingerprint ID to facial recognition ID), the TEE 106 may delete the linked cryptographic key. Thus, if a nefarious actor steals the user device 100, a linked cryptographic key will require a valid biometric ID, and even if the thief is able to register a new biometric ID, the linked cryptographic key will be wiped.

In some implementations, the user device 100 may generate cryptographic keys that are linked to a particular biometric ID. In some cases, the user 15 may manually configure the linking of cryptographic keys to the biometric ID as a setting in the user device 100. In some cases, the organization (e.g., the trusted issuer system 110 and/or authentication system 130) may manage the security settings of the user device 100. To generate a cryptographic key pair to a biometric template 116, the user 15 may first enroll their biometric ID. The user 15 may enroll their biometric ID using the settings of the OS 108. The user 15 may request enrollment, and the OS 108 may prompt the user for a biometric input 105. The user 15 may provide the biometric input 105, which the OS 108 may send to the TEE 106. The TEE 106 may process the biometric input 105 to generate the biometric template 116. For example, the TEE 106 may extract features from the biometric input 105. The extracted features may correspond to features expected to differ between different biometrics of the same kind (e.g., emphasizing the difference between fingerprint patterns on different fingers, geometric relationships between different facial features on different faces, etc.). In some implementations, the feature extractor may include a machine learning model trained to differentiate features between biometric inputs from different individuals, while recognizing similarity between biometric inputs from the same individual (e.g., using contrastive learning). The TEE 106 may quantify the extracted features to generate the biometric template 116 in the form of a multi-dimensional vector. The TEE 106 may store the biometric template 116 (e.g., the vector) in the secure storage 124. When the user device 100 receives a biometric input 105, it may send the biometric input 105 to the TEE 106 for comparison to the stored biometric templates 116. The TEE 106 may use the same feature extraction process to generate a vector of the biometric input 105, and compare the vector to those of the biometric templates. The TEE 106 may compare the biometric input vector to the biometric template vector(s) using one or algorithms; for example, determining a Hamming distance, Euclidian distance, cosine distance, dot product, etc., between the biometric input 105 and the biometric templates 116. The TEE 106 may return an indication of match if the similarity between the biometric input 105 and a biometric template 116 exceeds a particular threshold and/or satisfies some other condition for matching. If the TEE 106 determines that the biometric input 105 does not meet the similarity threshold with a biometric template 116, the TEE 106 may return an indication that no match was found and/or that the biometric input 105 could not be validated.

Once the user 15 has enrolled their biometric ID, the TEE 106 may be able to generate a cryptographic key pair (e.g., a Priv-K 112 and Pub-K 114) that is linked to the biometric template 116. The TEE 106 may store the Priv-K 112 in the secure storage 124. The Priv-K 112 may be stored securely such that it never leaves the TEE 106 or the user device 100. The TEE 106 may use the Priv-K 112 to apply digital signature to data such as the VC 115; however, the TEE 106 may condition use of the Priv-K 112 on matching a biometric input 105 to the biometric template 116 (e.g., the biometric template 116 that was enrolled at the time the Priv-K 112 and Pub-K 114 were generated). If the user 15 enrolls a new biometric ID, the TEE 106 may replace the biometric template 116 and delete any linked cryptographic keys.

The TEE 106 may allow use of the Pub-K 114 by the digital wallet 102 to, for example, request a VC 115 that is linked to the Priv-K 112. The digital wallet 102 may send the Pub-K 114 to the trusted issuer system 110. The trusted issuer system 110 may record the Pub-K 114 in the payload of the VC 115. The trusted issuer system 110 may return the VC 115 to the digital wallet 102, which may store it in the TEE 106. A VP is a document offered by a prover to a verifier to prove a claim; in this, case, that the user 15 possesses the correct VC 115. In some cases, the digital wallet 102 can use the TEE 106 to generate a VP 135 by digitally signing the VC 115 using the Priv-K 112. In some implementations, the TEE 106 can generate a VP 135 that selectively discloses one attribute or a subset of attributes without divulging all attributes in the VC 115. In some implementations, the TEE 106 can generate a VP 135 that represents a zero-knowledge proof (ZKP) of possession of the VC 115 without divulging any details of the VC 115 (e.g., the user's identity, attributes, etc.), as described further below. When the user requests a VP 135 and authenticates the request by providing a biometric input 105 that matches the biometric template 116 linked to the Priv-K 112, the digital wallet 102 may generate the VP 135 by digitally signing the VC 115 using the Priv-K 112. An entity verifying the VP 135 may extract the Pub-K 114 from the VP 135 and use it to check the digital signature. If the Pub-K 114 matches the digital signature on the VP 135, the verifier may trust that the user 15 is the proper holder of the VC 115. If the digital signature on the VC 115 in the VP 135 matches the public key of the trusted issuer system 110, the verifier can trust that the VC 115 was issued by the trusted issuer system 110 and, by extension, that the trusted issuer verified the user's identity.

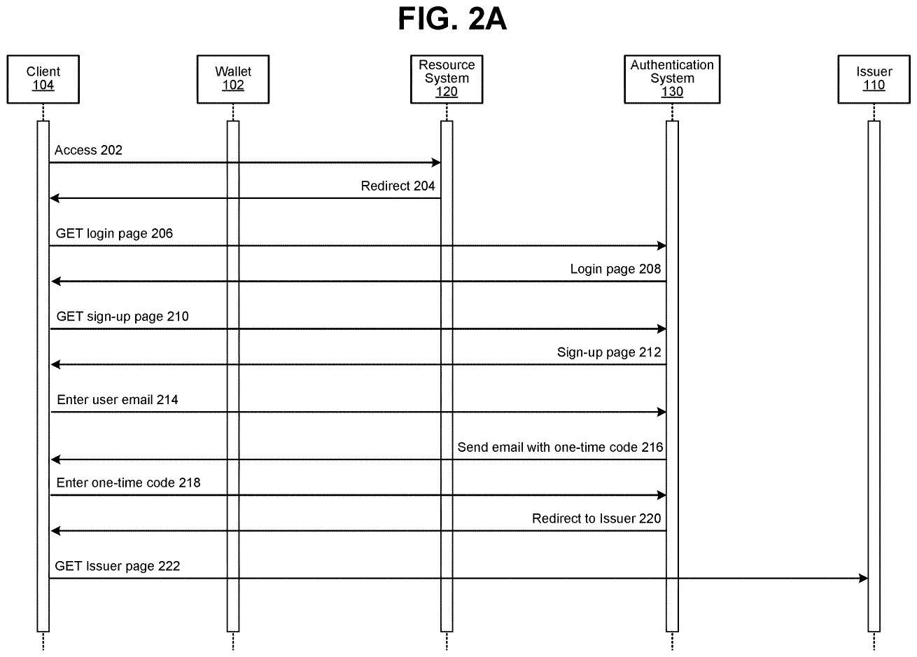

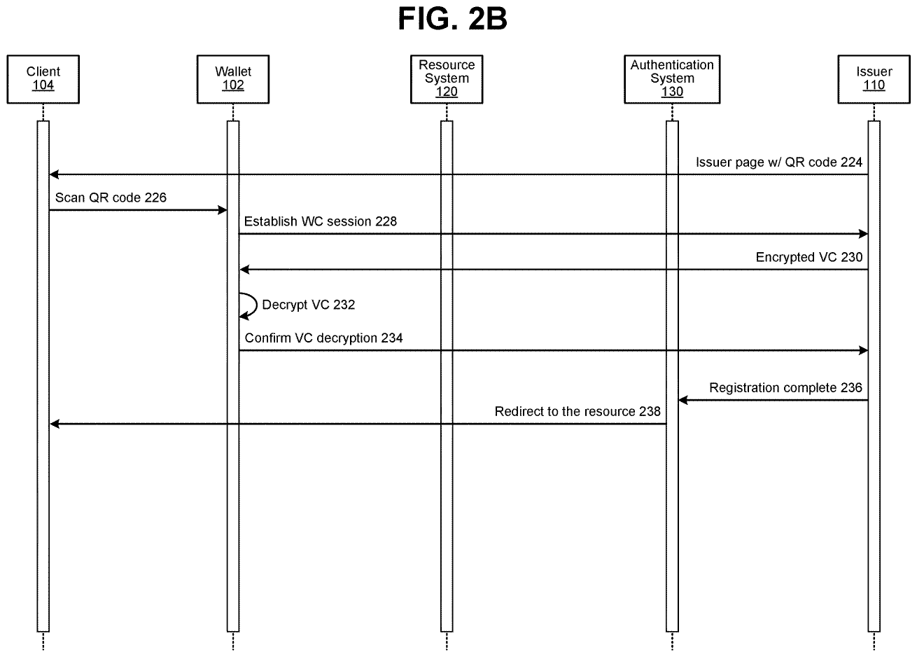

The trusted issuer system 110 may be responsible for verifying users'identities and issuing digital credentials such as VCs 115 attesting to the identity and/or attributes of the user 15. The identity represented in the VC 115 may correspond to a DID (e.g., associated with a cryptographic key pair generated by the user device 100a) and/or an identity within an organization of which the user 15 is a member. An example registration process is described in additional detail below with reference to FIGS. 2A and 2B.

The VC 115 may be a document, for example, a JavaScript Object Notation (JSON) file containing various pieces of information. For example, the VC 115 may include the identity of the issuer, an timestamp of issuance and/or expiry, a subject (e.g., identity of the holder), the subject identity attributes (e.g., the holder's title within an organization, age, citizenship, certifications held, etc.), and/or a cryptographic proof such as a digital signature of the trusted issuer.

In some implementations, a VC 115 may include multiple claims corresponding to different attributes. The trusted issuer system 110 may sign each claim in the VC 115 individually, which may allow the user 15 to selectively disclose individual attributes/claims. The user 15 may use the digital wallet 102 to select which attributes to disclose in a VP 135. The digital wallet 102 may generate the VP 135 for the individual attribute such that the verifying party can verify that the trusted issuer system's signature on the individual attribute. In addition, the digital wallet 102 can include in or with the VP 135 a hash of the entire VC 115, signed by the digital wallet 102. This may allow the verifying party to determine that the hash of the VC 115 matches the VC hash in an allowlist of valid VCs. But the hash of the entire VC 115 obscures the contents of the VC 115 such that none of the individual attributes can be extracted from the hash. In this manner, the verifying party may verify both the attribute and the current validity of the entire VC 115, but without seeing the other attributes contained in the VC 115.

In some implementations, the VP 135 can be a zero-knowledge proof (ZKP) of the identity and/or attribute the user 15 wishes to prove. For example, the user 15 may wish to prove that the trusted issuer system 110 has granted them permission to access the resource system(s) 120, without divulging their attributes when accessing the resource system(s) 120. A ZKP may allow a party to prove a claim without revealing any additional information. For example, a “prover” can share a proof of the claim with a “verifier” who can verify the accuracy of the proof. In some cases, a ZKP may not prove the claim with certainty, but the acts of proving and verifying may be repeated until the prover demonstrates to the verifier (and, in some case, an external observer or observers) a sufficiently high statistical likelihood that the claim is true, rather than a series of lucky guesses. In this case, the prover may be the user 15 and/or the user device 100, while the verifier may be the trusted issuer system 110, resource system(s) 120 authentication system 130, blockchain 140, and/or other entities or individuals operating in the system 101.

A ZKP of a claim may satisfy three properties: completeness, soundness, and zero-knowledge. Completeness means that if the claim is true, an honest prover can convince an honest verifier of the claim. Soundness means that if the claim is false, no cheating prover can convince an honest verifier of the claim (e.g., except for some very small probability, which may be reduced by further iterations of proof). Zero-knowledge means that if the claim is true, no verifier (or observer) will learn anything other than the fact that the claim is true.

A ZKP may be interactive or non-interactive. An interactive proof system may involve a repeated exchange of messages between the prover (e.g., the user device 100) and the verifier (e.g., the resource system(s) 120 and/or verifier system). In an interactive proof system, it may be assumed that the user device 100 has access to abundant computational resources but cannot be trusted. In contrast, the verifier system may be assumed to be trustworthy but have limited computational resources. The interactive proof system may also involve an ability of the verifier system to make random choices. Through an exchange of messages, the user device 100 may establish a near-certain likelihood that its claim is true, without divulging any information beyond the fact of the truth of the claim. For example, the verifier system may determine that receiving N consecutive verifiable proofs from a user device 100 makes the probability that the user device 100 is asserting a false claim exceedingly low. The resource system(s) 120 and/or the verifier system may select a value of N and/or a threshold confidence score (e.g., corresponding to a likelihood that the user device 100 possesses the credentials it asserts) based on, for example, the potential harm of a bad actor accessing the resource system(s) 120 and/or the sensitivity of the data stored therein. An example of a zero-knowledge protocol that may be used to perform an interactive ZKP is a zero-knowledge Scalable Transparent Argument of Knowledge (zk-STARK); however, some versions of zk-STARK may operate non-interactively.

A non-interactive ZKP may offer advantages over interactive proofs. For example, a non-interactive proof may be used when the prover and verifier cannot interact (e.g., communicate in real time). Thus, non-interactive proofs may be useful in decentralized systems such as a distributed ledger system made up of the distributed nodes. The distributed nodes may use the ZKP to verify transactions (e.g., adding new policies to the ledger) without oversight of a central authority. For example, a distributed node may verify that the trusted issuer system 110 (and/or other component of the system) is authorized to write policies, public keys, and/or other data to the distributed ledger system. An example of a non-interactive zero-knowledge protocol is a zero-knowledge Succinct Non-interactive Argument of Knowledge (zk-SNARK). A ZKP protocol (e.g., such as zk-SNARK, zk-STARK, and/or others) may be transparent and/or universal. A transparent protocol is one that does not require a trusted setup but may rely on public randomness. A universal protocol is one that does not require a separate trusted setup for each arithmetic circuit, where an arithmetic circuit represents a directed acyclic graph involving the addition and/or multiplication of numbers; for example, to compute a polynomial.

In some implementations, the trusted issuer system 110 (or other entity) may provide a trusted setup for the zero-knowledge proof. In some implementations, a different component (e.g., independent of the user device 100, the resource system(s) 120, and the authentication system 130) may provide the trusted setup. For example, the trusted issuer system 110 may send prover setup to the user device 100 and verifier setup to the authentication system 130. The prover setup and the verifier setup may be collectively referred to as a “trusted setup”. In some implementations, the prover setup may be data representing, for example, a prover key and/or a structured reference string. In some implementations, the verifier setup may be data representing, for example, a verifier key and/or a structured reference string. The trusted setup may facilitate the zero-knowledge proof between the user device 100 (e.g., the prover) and the authentication system 130 (e.g., the verifier). A ZKP may be used by the user 15 to establish to the authentication system 130 that the user 15 possesses credentials that correspond to policies for access of the resource system(s) 120. By using the ZKP, the user 15 may keep their exact identity hidden from the authentication system 130, the resource system(s) 120, and/or any observer(s) of the data that passes between the user device 100 and the authentication system 130. An observer may, however, be permitted to witness the operation(s) performed and/or the results thereof, and see that the authentication system 130 authorized the operation(s) based on a policy that may also be visible to the observer. The authentication process may therefore balance the interests of privacy for the user 15 and trust on the part of the observer.

In some implementations, the trusted issuer system 110 may provide VCs 115 to the user device 100. The user device 100 may include a TEE 106 or similar secure (e.g., encrypted) data storage component on and/or associated with the user device 100. The VCs 115 may correspond to one or more attributes about (or assigned to) the user 15. For each attribute (“att”), the trusted issuer system 110 may send to the user device 100:

σₐₜₜ=sign_{pk(IdP)}(att||pk_{Requestor})

The user 15 may wish to prove a claim c about an attribute; for example, that the user 15 is over the age of 18, the user 15 is a member of organization ABC, the user 15 is authorized to read, modify, and/or write data to the resource system(s) 120, the user 15 has been granted Tier-2 access but not Tier-1 access, etc. with respect to permissions for use of the resource system(s) 120. As can be appreciated, a number of claims/attributes are possible. The user 15 may prove to the authentication system 130 that c(att) is true, that the trusted issuer system 110 certifies that the user 15 has the attribute att, and that att was signed (e.g., that att was used to assert claim c).

If the ZKP protocol includes a trusted setup, the user 15 may fetch the prover setup from the trusted issuer system 110. The prover setup may represent a prover key for the corresponding claim PK_{IdP, c}.

Using the prover setup, the digital wallet 102 may build the following proof:

P_{att,Requestor,IdP}=Proof(σatt is valid and c(att)==true,PKIdP,c)

Which verifies that:

verify(σₐₜₜ,att∥pk_{Requestor})==true∧c(att)==true)

The user device 100 may send the proof P_{att, Requestor, IdP} to the resource system(s) 120 and/or the verifier system. If the ZKP protocol includes a trusted setup, the resource system(s) 120 and/or the verifier system may fetch the verifier setup from the trusted issuer system 110. The verifier setup may represent a verifier key for the corresponding claim VK_{IdP, c} and a structured reference string SRSIdP. The authentication system 130 may then verify the proof P from the user device 100:

Verify(P_{att, Requestor, IdP,}VK_{IdP,c},SRS_{IdP})==valid

If the claim c accurately represents the identity and/or attributes contained in the VC 115, the proof P will establish that c(att) is true and/or that the trusted issuer system 110 assigned att to the user 15. The authentication system 130 may then grant access to a protected resource (e.g., by creating an authentication token and sending it to the user device 100) or service and/or permission to execute a transaction. The user 15 may then use the resource system(s) 120 to obtain data 125.

The authentication system 130 is a system that can authenticate user identity and authorize access to online resources (e.g., apps hosted by the resource system 120, the blockchain 140, etc.). The authentication system 130 may perform various functions including simplifying user access to applications with single sign-on (SSO), managing passwords and access control for resource systems 120, and providing enhanced security via multi-factor authentication (MFA), etc.

In some implementations, the authentication system 130 may include components for handling various functions. For example, the authentication system 130 may include an ID manager, a verifier component, a user information endpoint, etc. The ID manager may include hardware and/or software configured to manage user registration, user identities, and online sessions (e.g., OIDC and blockchain sessions). In some implementations, the authentication system 130 may be implemented using software such as Keycloak. The authentication system 130 may receive redirects of requests to access the resource system(s) 120 when the requestor is not currently authenticated or engaged in an active session (e.g., corresponding to a valid and current authentication token 165). Once a request has been authenticated and a session created, the authentication system 130 may temporarily store session information 137 in a user profile associated with the user information endpoint. The client application 104 may use a wallet connect session to store and retrieve session information 137 to/from the user information endpoint, and provide the session information 137 to the resource (e.g., app) hosted by the resource system(s) 120. In some implementations, the authentication system 130 may include a verifier component having front end that can generate a QR code 133 for presentation on the client application 104. The user 15 can use their digital wallet 102 to scan the QR code 133 to generate a VP 135 from a VC 115 stored on the user device 100a. In some implementations, the authentication system 130 can create both a session for accessing the resource (e.g., an OIDC session) and a blockchain session that will allow the resource system(s) 120 to execute transactions on the blockchain 140 on the user's behalf.

The authentication system 130 may include hardware and/or software configured to create session identifiers (sessionIDs) for sessions created by the authentication system 130. The authentication system 130 may create a session cookie that contains the sessionID. The authentication system 130 state parameters (e.g., “verficationParameters”) for how a VP 135 should be verified for the session. The authentication system 130 may verify session status; for example, based on a username and temporary password provided by the client application 104 during authentication. In some cases, the authentication system 130 may additionally verify that the attributes in the VC/VP match the expected values stored in the user profile, and/or that the DID signature on the VP 135 matches the DID public key extracted from the VC 115. The authentication system 130 may store the user DID (e.g., extracted from the VC) in the user profile. Following successful authentication, the authentication system 130 may create an authentication token 165, which it may pass to the client application 104.

The authentication token 165 may be digital document granting the client application 104 access to the requested resource. In some cases, the authentication token 165 may be temporary, for example, by including an expiration time or date after which the user 15 will have to reauthenticate to continue accessing the resource. An authentication token 165 may or may not include a data payload. In some cases, the authentication token 165 may simply be a random string of characters that is digitally signed by the entity who issued the token (e.g., the authentication system 130). In some cases, the authentication token 165 may be a JavaScript Object Notation (JSON) Web Token (JWT). JSON is an open standard file format that may use human-readable text to store and transmit data. A JWT is a proposed Internet standard for creating data with a JSON payload, with optional encryption and/or digital signature. A JWT may encode data such as “claims,” which may correspond to user attributes, permissions, etc. If the JWT is signed by the trusted issuer system 110, a verifier (e.g., the authentication system 130 and/or the verifier system 150) may use the public key of the issuer to verify the claims. In some cases, the client application 104 may store the authentication token 165 in the local storage of the user device 100 on which the client application 104 is executing. In some cases, the client application 104 may hold an encrypted HTTP-only session cookie while the resource system 120 holds the corresponding JWT. This may allow the resource to use the JWT to communicate with the resource in an authenticated and/or secure manner. In contrast, the client application 104 may store sensitive information such as the session details corresponding to the wallet connect session in a secure browser storage of the client application 104 that is automatically cleared when the session ends; for example, when the browser tab is closed.

In some implementations, the authentication system 130 may include a verifier component having hardware and/or software configured to verify VPs 135. During authentication, the verifier component may generate a QR code 133 for presentation on the client application 104. The user 15 may scan the QR code 133 with their digital wallet 102 to generate a VP 135 and send it to the authentication system 130, which may verify the VP 135. Upon verifying the VP 135, the authentication system 130 may update the status of the session accordingly. In some implementations, the verifier component may be configured to verify VPs 135 that include selective disclosures and/or ZKPs of user attributes. In some implementations, the verifier component may refer to an allowlist and/or denylist of VCs prior to returning a verified/not-verified result. In some implementations, the allowlist and/or denylist may be stored on the blockchain 140 (which may be the same as or separate from the blockchain 140 with which the resource interacts).

In some implementations, the authentication system 130 may leverage a separate verifier system 150 to verify VPs 135. The authentication system 130 may indicate to the verifier system 150 verification parameters that the VP 135 must satisfy. The verifier system 150 may receive the VP 135 from the authentication system 130 or directly from the digital wallet 102. In either case, the verifier system 150 may return a verification result 155 to the authentication system 130.

The resource system(s) 120 may be a computer system hosting a resource such as an application, webapp, dApp, etc., that the user 15 wishes to access. The user 15 may access the resource by first registering with the trusted issuer system 110 to obtain a VC 115, and then authenticate with the authentication system 130 to obtain an authentication token 165. The user's client application 104 may use the authentication token 165 to access the resource for a limited time.

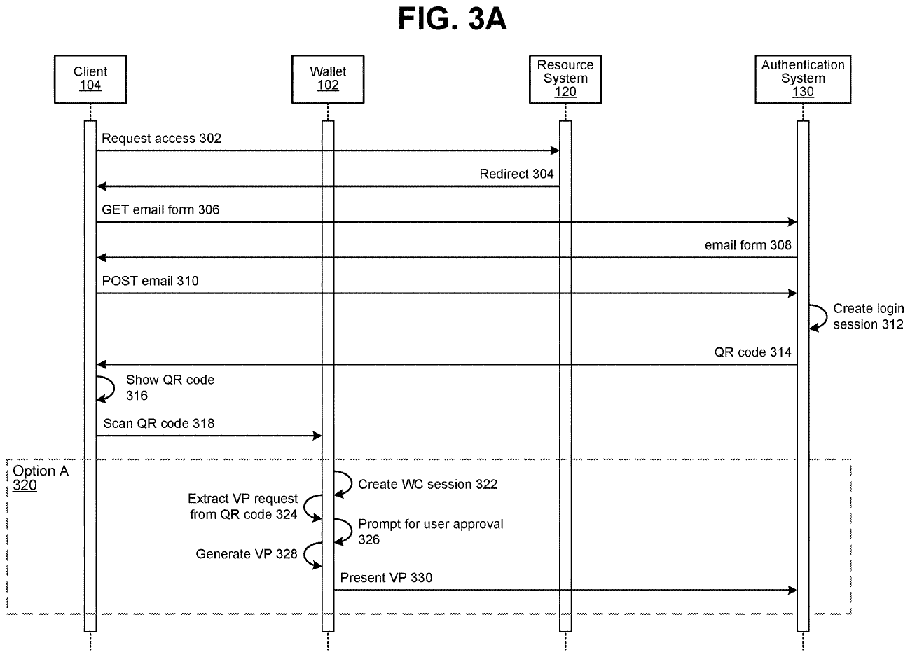

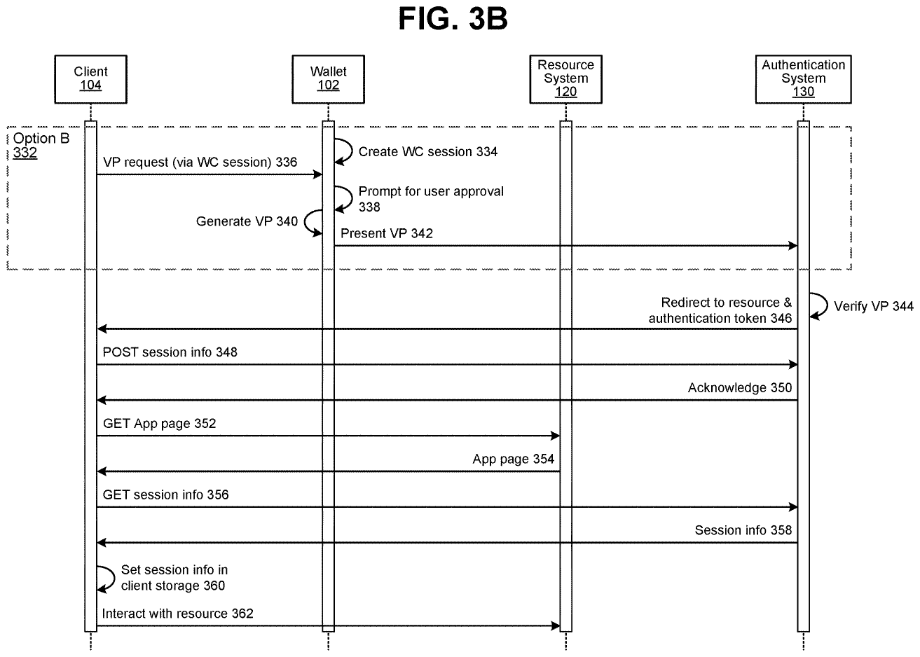

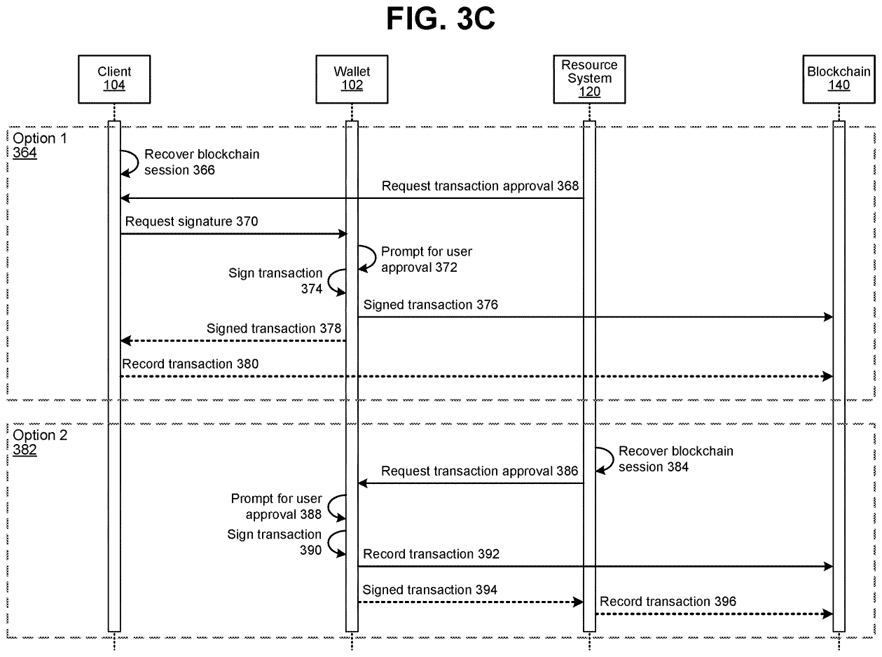

In some use cases, the user 15 may use the VC 115 to conduct secure transactions; for example, on the blockchain 140. For example, in some cases, the user 15 may carry a VC 115 that proves their ownership of a cryptocurrency account associated with the blockchain 140. Typically, a user may authenticate transactions for recording on the blockchain 140 using a separate flow from the flow used to authenticate with the resource system(s) 120; however, this increases the friction experienced by the user and may limit adoption or worse, cause a user to look for shortcuts that may involve security risks. Thus, in some implementations, the authentication system 130 can, in the same flow, authenticate the user to access the resource while also establishing a wallet connect session for blockchain transactions; for example, as shown in FIGS. 3A through 3C described below. In this manner, the user 15 may authenticate with the resource and open a blockchain connection (e.g., a wallet connect session between the client application 104 accessing the resource and the digital wallet 102 holding the cryptographic key for blockchain transactions) at the same time, thus allowing the user 15 to engage in blockchain transactions with the resource.

For example, the authentication token 165 may grant the client application 104 access to interact with the resource system(s) 120 to execute a transaction involving crediting or debiting a cryptocurrency account maintained on the blockchain 140. To record the transaction 145 on the blockchain 140, the resource may use the blockchain session (e.g., the wallet connect session between the client application 104 and the digital wallet 102) to obtain a digital signature of the digital wallet 102 (e.g., corresponding to a Priv-K 112) for the transaction 145. The digital wallet 102 or the resource may then record the signed transaction to the blockchain 140.

In some cases, the record of the transaction 145 may include or exclude various information. For example, in some cases, the transaction 145 may be recorded anonymously by including certain information about the transaction (e.g., time, date, amount) while excluding the identity of the user 15. In any case, the blockchain node(s) may verify that the digital signature corresponds to an authorized party prior to recording the transaction 145, even if the public key, DID, or other identifying information of the user 15 is ultimately omitted from the record of the transaction 145 memorialized in the blockchain 140.

FIGS. 2A and 2B are signal flow diagrams illustrating an example registration process, according to embodiments of the present disclosure. A user 15 may use their user device(s) 100 to request access to a resource hosted by resource systems 120. The user device(s) 100 may include a digital wallet 102 and a client application 104. In some cases, the digital wallet 102 and the client application 104 may be on the same user device 100. In some cases, the digital wallet 102 may be on the first user device 100a while the client application 104 may be on the second user device 100b. In either case, the user 15 may navigate the client application 104 to a sign-in page of the resource, which may be an application, website, webapp, dApp, etc., hosted by the resource system 120. If the client application 104 is not currently engaged in a valid session with the resource system 120, the resource system 120 may redirect the client application 104 to a sign-up page hosted by the authentication system 130. The sign-up page may prompt the user 15 to enter their email address to which the authentication system 130 can send a verification link. The user 15 may receive the email and follow the provided verification link. The verification link will bring the client application 104 to an endpoint hosted by the authentication system 130, which will redirect the client application 104 to the trusted issuer system 110. The trusted issuer system 110 may provide the client application 104 with a QR code 113 that the user can scan to obtain a VC, which the user 15 use to gain access to the resource system 120 (e.g., using a process like the one illustrated in FIGS. 3A through 3C as described further below).

In further detail, the registration process may proceed as follows. At step 202, the user 15 may use the client application 104 to request resource hosted by the resource system 120. If the resource system 120 determines that the user 15 is not currently engaged in a valid session, the resource system 120 may, at step 204, redirect the client application 104 to the authentication system 130. Upon the redirect, at step 206, the client application 104 may request a login page of the authentication system 130 (e.g., using a GET command). At step 208, the authentication system 130 may present the login page to the client application 104. The login page may include a hyperlink to a sign-up page, where the user 15 may register to receive a VC for accessing the app or app site. If the user 15 does not have a VC or other credential with which to log in, the user may select the sign-up page link. At step 210, the client application 104 may select the link to request the sign-up page (e.g., using a GET command). At step 212, the authentication system 130 may present the sign-up page to the client application 104. The sign-up page may prompt the user 15 for the email address the user 15 wishes to use to obtain the VC. The user 15 may enter their email address (e.g., manually or auto-filled by or into the client application 104) and, at step 214, the client may send the email address to the authentication system 130. The authentication system 130 may verify the email address by, for example, checking that it includes a valid domain and that the address corresponds to an account permitted to receive a VC for accessing the app or app site. If the email address is valid/permitted, the authentication system 130 may, at step 216, send a verification email to the email address (e.g., via webmail, simple mail transfer protocol (SMTP), Internet message access protocol (IMAP), post office protocol version 3 (POP3), etc.). The verification email may include a one-time verification code (e.g., a PIN) that the user 15 can use to continue the registration process.

At step 218, the user 15 may receive the email and enter the verification code into the sign-up page presented by the authentication system 130. Upon confirming the verification code, the authentication system 130 may, at step 220, send the client application 104 a redirect message that will bring the client application 104 to the trusted issuer system 110. The redirect message may include an HTTP status code 302, which can indicate a temporary relocation of the requested resource to a different URL (e.g., corresponding to a different endpoint hosted by the trusted issuer system 110). The redirect message may include one or more attributes such as the email address and/or username of the user 15. Upon being redirected, the client application 104 may, at step 222, request an issuer page from the trusted issuer system 110. The trusted issuer system 110 may, at step 224, present the issuer page to the client application 104. The issuer page may include a QR code 113 that the user 15 can scan using their digital wallet 102 to establish a wallet connect session between the digital wallet 102 and the trusted issuer system 110.

The registration process may continue with the steps shown in FIG. 2B. The client application 104 may display the QR code 113. At step 226, the user 15 may cause the digital wallet 102 to scan the QR code 113. At step 228, the digital wallet 102 may use the information in the QR code 113 to establish the wallet connect session between the digital wallet 102 and the trusted issuer system 110. The trusted issuer system 110 may generate a VC based on the DID associated with the digital wallet 102/user 15 (e.g., a Priv-K 112). The VC may include one or more attributes including the DID, the email address of the user (e.g., provided at step 214), the domain of the resource, etc. In some cases, the trusted issuer system 110 may encrypt the VC prior to transmission to the digital wallet 102. With the wallet connection session established at step 228, the trusted issuer system 110 may, at step 230, send the VC to the digital wallet 102 via the wallet connection session. The digital wallet 102 may receive the VC and, at step 232, decrypt the VC in various ways. In some cases, the digital wallet 102 and the trusted issuer system 110 may exchange cryptographic keys (e.g., via the wallet connect session or a secure side channel). In some cases, the trusted issuer system 110 may present the client application 104 with a subsequent page showing a confirmation code or PIN (personal identification number) that the user may enter into the digital wallet 102 to decrypt the VC. After decrypting the VC, the digital wallet 102 may, at step 234, send a confirmation of receipt/decryption of the VC back to the trusted issuer system 110. Upon receiving the confirmation, the trusted issuer system 110 may, at step 236, send a message to the authentication system 130 that the registration process has been completed. At step 238, the authentication system 130 may redirect the client application 104 to the sign-in page of the resource system 120. Following the redirect, the user 15 may use the VC to authenticate with the resource and/or open a blockchain connection, using a process like the one illustrated in FIGS. 3A through 3B.

FIGS. 3A and 3B are signal flow diagrams illustrating an example login process, according to embodiments of the present disclosure. It is presumed that the user 15 has obtained the required VC and stored it in their digital wallet 102 (e.g., via a process such as the one illustrated in FIGS. 2A and 2B). The user 15 may then use their user device(s) 100 to gain access to a resource hosted by resource system(s) 120, and permit the resource to execute blockchain transactions on the user's behalf. The user 15 may use their client application 104 to request access to a resource. The resource system(s) 120 hosting the resource may redirect the client application 104 to the authentication system 130 to begin the login process. The authentication system 130 may present the client application 104 with a QR code 133. The user 15 can scan a QR code 133 using their digital wallet 102 to generate a VP and send it to the authentication system 130. If the VP is valid, the authentication system 130 may provide the client application 104 with an authentication token 165 and redirect it to the resource. The digital wallet 102 can create a blockchain session that the resource can use to obtain approval to execute blockchain transactions on the user's behalf.

In further detail, the login steps may be as follows. At step 302, the user 15 may navigate the client application 104 to the resource (e.g., the webpage of a dApp). If the client application 104 is not currently logged in, the resource system 120 hosting the resource may, at step 304, redirect the client application 104 to a login page of the authentication system 130. The redirect may cause the client application 104 to, at step 306, send a request to the authentication system 130 for an email form into which the user 15 may enter their email address. At step 308, the authentication system 130 may send the email form to the client application 104, which may present it to the user 15. The user 15 may enter their email address and, at step 310, the client application 104 may send the email address to the authentication system 130. At step 312, the authentication system 130 may create a temporary login session. The login session may have a sessionID and parameters for how a VP should be verified for the session (e.g., “verficationParameters”). For example, the session parameters may include attributes that the user 15 must establish to login.

At step 314, the authentication system 130 may send the client application 104 a QR code 133 corresponding to the session(ID), which is then shown 316 on a display of the client device 100b. The QR code 133 may include information for establishing a wallet connect session between the digital wallet 102 and the client application 104 and may, in some cases, additionally include a request for a VP, including the verificationParameters. At step 318, the client application 104 may display the QR code 133 (e.g., on a display 616). In some implementations, the client application 104 may, send the authentication system 130 a request to subscribe to a session info callback for the sessionID. This may allow the client application 104 to receive a session status update when authentication system 130 verifies the VP generated by the digital wallet 102. The client application 104 may subscribe using a GET command (e.g., “GET/login/session/{sessionID}/status/”). The authentication system 130 may periodically send a status of the session corresponding to the sessionID (e.g., every 1, 2, 5 second, etc.). When the client application 104 receives a status update indicating the session has authenticated, the client application 104 can request an action URL from the authentication system 130. At step 318, the user 15 may scan the QR code 133 displayed by the client application 104 using their digital wallet 102.

The manner in which the digital wallet 102 generates and present the VP may depend on the contents of the QR code 133. For example, in Option A 320, the QR code 133 includes information for both creating a wallet connect session and generating the VP. In Option B 332, the QR code may include information for creating the wallet connect session, and the digital wallet 102 may obtain information for generating the VP from the client application 104 via the wallet connect session.

In Option A 320, the digital wallet 102 may, at step 322 create a wallet connect session based on the information in the QR code 133. At step 324, the digital wallet 102 may extract the VP request from the QR code. At step 326, the digital wallet 102 may prompt the user 15 for approval. The user 15 may enter their approval (e.g., by swiping “yes,” entering a PIN, inputting a biometric ID, etc.). Upon receiving the user's approval, the digital wallet 102 may, at step 328, use the VC (e.g., previously received from the trusted issuer system 110) to generate a VP that demonstrates possession of the VC. At step 330, the digital wallet 102 may send the VP to the authentication system 130 (e.g., using a POST command: “POST/login/presentation/”).

The operations may continue on FIG. 3B. In Option B 332, the digital wallet 102 may, at step 334, use the information in the QR code to establish a wallet connect session with the client application 104. In this case, however, the QR code may not include information for presenting a VP; thus, at step 336, the digital wallet 102 may obtain the VP request from the client application 104 via the wallet connect session created at step 334. At step 338, the digital wallet 102 may prompt the user 15 for approval. Upon receiving the user's approval, the digital wallet 102 may, at step 340, use the VC (e.g., previously received from the trusted issuer system 110) to generate a VP that demonstrates possession of the VC. At step 342, the digital wallet 102 may send the VP to the authentication system 130

In either case (e.g., Option A or Option B) the authentication system 130 may, at step 344, verify the VP and, if verification is successful, update the session status for session ID. verification of the VP may include verifying a username and/or temporary password, determining that the VC/VP match expected values stored in a user profile of the user, that the VC matches criteria necessary for accessing the requested resource, that the digital signature on the VC corresponds to the trusted issuer system 110, and/or that the VP satisfies other requirements of the verificationParameters. In some cases, the authentication system 130 may verify the VP itself, while in other cases the verifier system 150 may verify the VP (e.g., by receiving it from the authentication system 130 or from the digital wallet 102 directly).

Upon verifying the VP, the authentication system 130 may grant the user 15 access to the resource and create a blockchain session that may allow the resource system to execute transactions on the blockchain 140 on behalf of the user. At step 346, the authentication system 130 may redirect the client application 104 to the requested resource. The redirect may include an HTTP status code 304 indicating that the client application 104 does not need to resubmit the request. In addition, the ID access manager may send the client application 104 an authentication token 165, which will allow the client application 104 to make authenticated requests to the resource.

Following the redirect at step 346, the client application 104 may perform operations to retrieve the blockchain session information 137 from the authentication system 130 and make it available for interactions with the resource. For example, the client application 104 may maintain the session information in a secure browser storage associated with the domain of the authentication system 130. The client application 104 may perform the following operations to store the session information in a secure browser storage associated with the domain of the resource.

At step 348, the client application 104 may send the session information to the authentication system 130 (e.g., using an HTTP POST command). At step 350, the authentication system 130 may acknowledge receipt of the session information. At step 352, the client application 104 may request the application page from the resource (e.g., using a GET command). The resource system(s) 120 may return the application page at step 354. At step 356, the client application 104 may retrieve the session information from the authentication system 130. The authentication system 130 may return the session information at step 358. At step 360, the client application 104 may store the session information in the secure local storage corresponding to the domain of the resource. The client application's secure session storage may be used to store sensitive data that will be cleared when the session ends (e.g., the browser tab is closed, the app is exited, the user device 100 is powered down, etc.). The secure session storage is distinct from the local storage of the user device 100, which may be used to store non-sensitive and/or public data, and which may persist across sessions and/or after a session has ended. Having the blockchain session information in the secure browser storage corresponding to the resource's domain may allow the client application 104 to recover the wallet connect session for use in approving blockchain transaction requests from the resource. At step 362, the client application 104 may interact with the resource to, for example, read, write, and/or modify data as well as engage in other operations such as those involving executing transactions on the blockchain 140.

With login complete and the blockchain session established, the process may continue with the steps shown in FIG. 3C. When the user 15 interacts with the resource to perform operations that involve blockchain transactions, the client application 104 or the resource can recover the blockchain session for the purpose of obtaining approval for and/or signing of a blockchain transaction. FIG. 3C illustrates both options: in Option 1 364, the client application 104 recovers the blockchain session; in Option 2 382, the resource system 120 recovers the blockchain session.

In Option 1 364, the client application 104 can recover the blockchain session at step 366. The blockchain session may be a wallet connect session between the client application 104 and the digital wallet 102 that allows the digital wallet 102 to approve transactions initiated by an interaction between the client application 104 and the resource. At step 368, the resource may send the client application 104 a request for approval for a blockchain transaction. At step 370, the client application 104 may send the requested transaction to the digital wallet 102 (via the wallet connect session) for signature. At step 372, the digital wallet 102 may prompt the user 15 for approval. Upon obtaining approval, the digital wallet 102 may, at step 374, digitally sign the transaction. The digital wallet 102 can handle the now-signed blockchain transaction in multiple ways. For example, in some cases, the digital wallet 102 can send the signed transaction directly to the blockchain 140 at step 376. Alternatively, the digital wallet 102 can return the signed transaction to the client application 104 at step 378, and the client application 104 can record the transaction to the blockchain 140 at step 380.

In Option 2 382, the resource can recover the blockchain session at step 384. In this case, the resource can use the blockchain session to request transaction approval directly from the digital wallet 102 at step 386. At step 388, the digital wallet 102 may prompt the user 15 for approval. Upon obtaining approval, the digital wallet 102 may, at step 390, digitally sign the transaction. The digital wallet 102 can handle the now-signed blockchain transaction in multiple ways. For example, in some cases, the digital wallet 102 can send the signed transaction directly to the blockchain 140 at step 392. Alternatively, the digital wallet 102 can return the signed transaction to the resource at step 394, and the resource can record the transaction to the blockchain 140 at step 396.

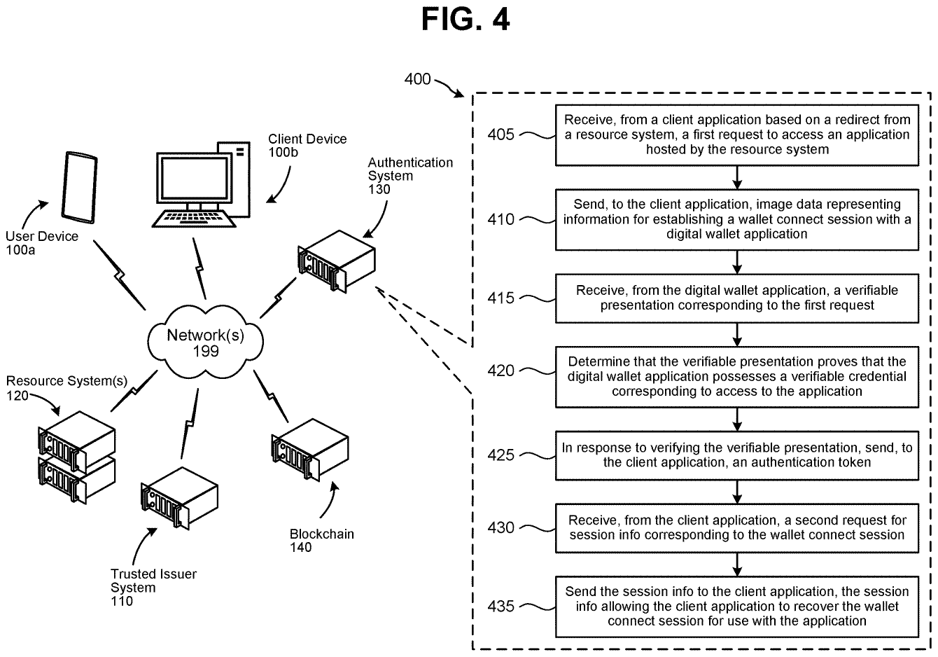

FIG. 4 is a conceptual diagram illustrating an example method 400 of facilitating user authentication and blockchain connection, according to embodiments of the present disclosure. The method 400 may be performed by the authentication system 130 as described herein. The method 400 may include receiving (405), from the client application based on a redirect from the resource system, a first request to access an application hosted by the resource system. The method 400 may include sending (410), to the client application, image data (e.g., a QR code) representing information for establishing a wallet connect session with a digital wallet application. The user may scan the image data with the digital wallet application. In some cases, the image data may encode a request for a VP that may be used to authenticate the first request. In other cases, the digital wallet application may use the information in the image data to establish a wallet connect session with the client application, and the method may include sending the VP request to the digital wallet application via the wallet connect session. The method 400 may include receiving (415), from the digital wallet application, a verifiable presentation corresponding to the first request. For example, the digital wallet application may send the verifiable presentation in response to a VP request received via the wallet connect session or extracted from the QR code. The method 400 may include determining (420) that the verifiable presentation proves that the digital wallet application possesses a verifiable credential corresponding to access to the application. The method 400 may include sending (425), to the client application in response to verifying the verifiable presentation, an authentication token that will allow the client application to access the application. The method 400 may include receiving (430), from the client application, a second request for session information corresponding to the wallet connect session. The method 400 may include sending (435) first data representing the session information to the client application, the first data allowing the client application to recover the wallet connect session for use with the application. The steps 430 and 435 may allow the client application to transfer the session information from a first secure browser storage corresponding to a domain of the authentication system 130 to a second secure browser storage corresponding to a domain of the resource system 120 hosting the first application.

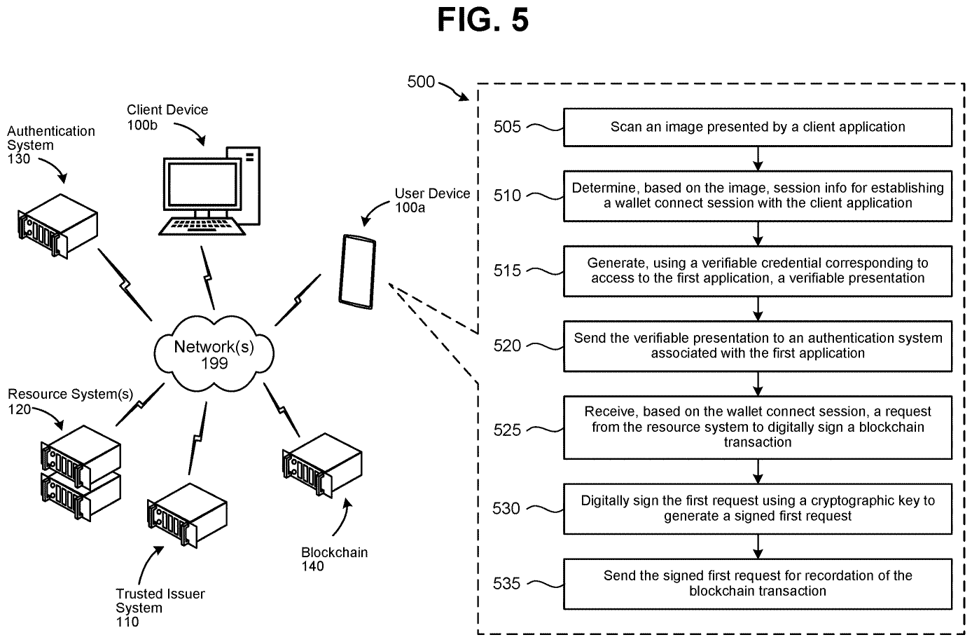

FIG. 5 is a conceptual diagram illustrating an example method 500 of obtaining user authentication and blockchain connection, according to embodiments of the present disclosure. The method 500 may be performed by a user device executing a digital wallet application (e.g., a user device 100a and a digital wallet 102). In some implementations, one or more of the operations may be performed in conjunction with a client application executing on the same or a different user device. The method 500 may include scanning (505), by a digital wallet application using a camera of a first device, a first image presented by a client application used to send a first request for access to a first application hosted by a resource system. The camera may capture image data, and the method 500 may include determining (510), based on the image data, session information for establishing a wallet connect session between the digital wallet application and the client application. The method 500 may include generating (515), using a verifiable credential corresponding to access to the first application, a verifiable presentation corresponding to the first request. For example, the authentication system 130 can determine whether the verifiable presentation proves that the digital wallet application possesses a verifiable credential that matches criteria necessary for accessing the requested application. The digital wallet application may generate the verifiable presentation in response to a VP request that was encoded in the image data (e.g., a QR code) or obtained from the client application via the wallet connect session. The digital wallet application may have previously registered to obtain the verifiable credential from the trusted issuer system 110. The method 500 may include sending (520) the verifiable presentation to the authentication system 130, which may be associated with the first application. The authentication system 130 may verify the verifiable presentation and authenticate the client application. The client application may receive an authentication token that may allow it to access the first application. The client application may further transfer the session information to a secure local storage corresponding to the domain of the first application (e.g., which may be different from the domain of the authentication system 130). Then, either the client application or the first application may use the session information to recover the wallet connect session for purposes of sending blockchain transaction approval requests to the digital wallet application for signature. The method 500 may include receiving (525), based on the wallet connect session, a second request from the resource system to digitally sign a blockchain transaction. The method 500 may include digitally signing (530) the first request using a cryptographic key corresponding to the digital wallet application to generate a signed first request. The method 500 may include sending (535) the signed first request for recordation of the blockchain transaction. The digital wallet application may send the signed transaction directly to the blockchain 140, or back to the entity from which it received the request. For example, if the digital wallet application received the approval request from the client application, the digital wallet application may return the signed request to the client application. If the digital wallet application received the approval request from the first application, the digital wallet application may return the signed request to the first application.

FIG. 6 is a block diagram illustrating an example user device 100 and system device 600 communicating over a computer network 199, according to embodiments of the present disclosure. While the user device(s) 100 may operate locally to a user (e.g., within a same environment so the device may receive inputs and playback outputs for the requestor) the system device(s) 600 may be located remotely from the user device(s) 100. The system device(s) 600 may be located in an entirely different location from the user device 100 (for example, as part of a cloud computing system or the like).

A user device 100 may include one or more controllers/processors 604, which may each include a central processing unit (CPU) for processing data and computer-readable instructions, and a memory 606 for storing data and instructions of the respective device. The memories 606 may individually include volatile random-access memory (RAM), non-volatile read only memory (ROM), non-volatile magnetoresistive memory (MRAM), and/or other types of memory. The user device 100 may also include a data storage component 608 for storing data and controller/processor-executable instructions. Each data storage component 608 may individually include one or more non-volatile storage types such as magnetic storage, optical storage, solid-state storage, etc. The user device 100 may also be connected to removable or external non-volatile memory and/or storage (such as a removable memory card, memory key drive, networked storage, etc.) through respective input/output device interfaces 602.

Computer instructions for operating the user device 100 and its various components may be executed by the respective device's controller(s)/processor(s) 604, using the memory 606 as temporary “working” storage at runtime. A user device's computer instructions may be stored in a non-transitory manner in non-volatile memory 606, data storage component 608, or an external device(s). Alternatively, some or all of the executable instructions may be embedded in hardware or firmware on the respective device in addition to or instead of software.

In some implementations, the user device 100 may include a TEE 106 as previously described. In some implementations, the TEE 106 may be separate and secure portions of the controller(s)/processor(s) 604, memory 606, and/or data storage component 608. In some implementations, the TEE 106 may have its own dedicated and secure controller(s)/processor(s), memory, and/or storage.

The user device 100 includes input/output device interfaces 602. A variety of components may be connected through the input/output device interfaces 602, as will be discussed further below. Additionally, the user device 100 may include an address/data bus 610 for conveying data among components of the respective device. Each component within the user device 100 may also be directly connected to other components in addition to (or instead of) being connected to other components across the bus 610.

The user device 100 may include input/output device interfaces 602 that connect to a variety of components such as an audio output component such as a speaker 612, a wired headset or a wireless headset (not illustrated), or other component capable of outputting audio. The user device 100 may also include an audio capture component. The audio capture component may be, for example, a microphone 620 or array of microphones, a wired headset or a wireless headset (not illustrated), etc. If an array of microphones is included, approximate distance to a sound's point of origin may be determined by acoustic localization based on time and amplitude differences between sounds captured by different microphones of the array. The user device 100 may additionally include a display 616 for displaying content. The user device 100 may further include a camera 618.

Via antenna(s) 622, the input/output device interfaces 602 may connect to one or more computer networks 199 via a wireless local area network (WLAN) (such as Wi-Fi) radio, Bluetooth, and/or wireless network radio, such as a radio capable of communication with a wireless communication network such as a Long-Term Evolution (LTE) network, WiMAX network, 3G network, 4G network, 5G network, etc. A wired connection such as Ethernet may also be supported. Through the network(s) 199, the system may be distributed across a networked environment. The I/O device interface 602 may also include communication components that allow data to be exchanged between devices such as different physical servers in a collection of servers or other components.

A system device 600 may include one or more physical devices and/or one or more virtual devices, such as virtual systems that run in a cloud server or similar environment. The system device 600 may include one or more input/output device interfaces 652 and controllers/processors 654. The system device 600 may further include a memory 656 and storage 658. A bus 660 may allow the input/output device interfaces 652, controllers/processors 654, memory 656, and storage 658 to communicate with each other; the components may instead or in addition be directly connected to each other or be connected via a different bus.

A variety of components may be connected through the input/output device interfaces 652. For example, the input/output device interfaces 652 may be used to connect to the computer network 199. Further components include keyboards, mice, displays, touchscreens, microphones, speakers, and any other type of user input/output device. The components may further include USB drives, removable hard drives, or any other type of removable storage.

The controllers/processors 654 may process data and computer-readable instructions and may include a general-purpose central-processing unit, a specific-purpose processor such as a graphics processor, a digital-signal processor, an application-specific integrated circuit, a microcontroller, or any other type of controller or processor. The memory 656 may include volatile random-access memory (RAM), non-volatile read only memory (ROM), non-volatile magnetoresistive (MRAM), and/or other types of memory. The memory 656 may be used for storing data and controller/processor-executable instructions on one or more non-volatile storage types, such as magnetic storage, optical storage, solid-state storage, etc.

Computer instructions for operating the system device 600 and its various components may be executed by the controller(s)/processor(s) 654 using the memory 656 as temporary “working” storage at runtime. The computer instructions may be stored in a non-transitory manner in the memory 656, storage 658, and/or external memory and/or storage device(s). Alternatively, some or all of the executable instructions may be embedded in hardware or firmware on the respective device in addition to or instead of software.

The above aspects of the present disclosure are meant to be illustrative. They were chosen to explain the principles and application of the disclosure and are not intended to be exhaustive or to limit the disclosure. Many modifications and variations of the disclosed aspects may be apparent to those of skill in the art. Persons having ordinary skill in the field of computers and data processing should recognize that components and process steps described herein may be interchangeable with other components or steps, or combinations of components or steps, and still achieve the benefits and advantages of the present disclosure. Moreover, it should be apparent to one skilled in the art that the disclosure may be practiced without some or all of the specific details and steps disclosed herein.

Aspects of the disclosed system may be implemented as a computer method or as an article of manufacture such as a memory device or non-transitory computer readable storage medium. The computer readable storage medium may be readable by a computer and may comprise instructions for causing a computer or other device to perform processes described in the present disclosure. The computer readable storage medium may be implemented by a volatile computer memory, non-volatile computer memory, hard drive, solid-state memory, flash drive, removable disk, and/or other media. In addition, components of one or more of the modules and engines may be implemented as in firmware or hardware.

Conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without other input or prompting, whether these features, elements and/or steps are included or are to be performed in any particular embodiment. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list.

Disjunctive language such as the phrase “at least one of X, Y, Z,” unless specifically stated otherwise, is otherwise understood with the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present. As used in this disclosure, the term “a” or “one” may include one or more items unless specifically stated otherwise. Further, the phrase “based on” is intended to mean “based at least in part on” unless specifically stated otherwise.

What is claimed is:

1. A computer-implemented method comprising:
receiving, from a client application based on a redirect from a resource system, a first request to access a first application hosted by the resource system;
sending, to the client application, image data representing information for establishing a wallet connect session with a digital wallet application;
receiving, from the digital wallet application, a verifiable presentation corresponding to the first request;
determining that the verifiable presentation proves that the digital wallet application possesses a verifiable credential corresponding to access to the first application;
in response to determining that the verifiable presentation proves that the digital wallet application possesses the verifiable credential, sending, to the client application, an authentication token for accessing the first application;
receiving, from the client application, a second request for session information corresponding to the wallet connect session; and
sending first data representing the session information to the client application, the first data allowing the client application to recover the wallet connect session for use with the first application.

2. The computer-implemented method of claim 1, further comprising:
prior to sending the image data, encoding a third request for the verifiable presentation in the image data.

3. The computer-implemented method of claim 1, further comprising:
prior to receiving the verifiable presentation, sending a third request for the verifiable presentation to the client application, the client application sending the third request to the digital wallet application via the wallet connect session.

4. The computer-implemented method of claim 1, further comprising, prior to receiving the first request:
receiving, from the client application based on a redirect from the resource system, a third request to access the first application;
determining that the third request does not correspond to a valid session;
in response to determining that the third request does not correspond to a valid session, sending a verification link to the client application;
receiving, from a trusted issuer system, an indication that registration is complete; and
in response to receiving the indication, redirecting the client application to the resource system.

5. The computer-implemented method of claim 4, further comprising:
receiving, from the client application prior to receiving the indication, a fourth request corresponding to the verification link; and
redirecting the client application to the trusted issuer system, wherein the indication indicates that the trusted issuer system has provided a verifiable credential to a digital wallet application associated with the client application.

6. The computer-implemented method of claim 1, wherein the wallet connect session allows the first application to send the digital wallet application a third request to approve a blockchain transaction requested by the client application.

7. The computer-implemented method of claim 1, wherein:
the client application stores the first data in a secure browser storage corresponding to a first domain of the first application, and
the method further comprises:
prior to receiving the second request, receiving the first data from the client application, the client application sending the first data from a second secure browser storage corresponding to a second domain different from the first domain.

8. A computer-implemented method comprising:
scanning, by a digital wallet application using a camera of a first device, a first image to determine first image data, the first image presented by a client application used to send a first request for access to a first application hosted by a resource system;
determining, based on the first image data, session information for establishing a wallet connect session between the digital wallet application and the client application;
generating, using a verifiable credential corresponding to access to the first application, a verifiable presentation corresponding to the first request;
sending the verifiable presentation to an authentication system associated with the first application;
receiving, based on the wallet connect session, a second request from the resource system to digitally sign a blockchain transaction;
signing the first request using a cryptographic key corresponding to the digital wallet application to generate a signed first request; and
sending the signed first request for recordation of the blockchain transaction.

9. The computer-implemented method of claim 8, further comprising:
prior to generating the verifiable presentation, extracting, from the first image data, a third request for the verifiable presentation, wherein the digital wallet application generates the verifiable presentation based on the third request.

10. The computer-implemented method of claim 8, further comprising:
prior to generating the verifiable presentation, establishing, based on the session information, the wallet connect session; and
receiving, from the client application via the wallet connect session, a third request for the verifiable presentation, wherein the digital wallet application generates the verifiable presentation based on the third request.

11. The computer-implemented method of claim 8, wherein the authentication system sends, in response to verifying the verifiable presentation, an authentication token for accessing the first application to the client application.

12. The computer-implemented method of claim 8, wherein:
prior to receiving the second request, the client application recovers the wallet connect session; and
the digital wallet application receives the second request from the client application via the recovered wallet connect session.

13. The computer-implemented method of claim 8, wherein:
prior to receiving the second request, the first application recovers the wallet connect session; and
the digital wallet application receives the second request from the first application via the recovered wallet connect session.

14. A system, comprising:
at least one processor; and
at least one memory comprising instructions that, when executed by the at least one processor, cause the system to:
receive, from a client application based on a redirect from a resource system, a first request to access a first application hosted by the resource system;
send, to the client application, image data representing information for establishing a wallet connect session with a digital wallet application;
receive, from the digital wallet application, a verifiable presentation corresponding to the first request;
determine that the verifiable presentation proves that the digital wallet application possesses a verifiable credential corresponding to access to the first application;
in response to determining that the verifiable presentation proves that the digital wallet application possesses the verifiable credential, send, to the client application, an authentication token for accessing the first application;
receive, from the client application, a second request for session information corresponding to the wallet connect session; and
send first data representing the session information to the client application, the first data allowing the client application to recover the wallet connect session for use with the first application.

15. The system of claim 14, wherein the at least one memory further comprises instructions that, when executed by the at least one processor, further cause the system to:
prior to sending the image data, encode a third request for the verifiable presentation in the image data.

16. The system of claim 14, wherein the at least one memory further comprises instructions that, when executed by the at least one processor, further cause the system to:
prior to receiving the verifiable presentation, send a third request for the verifiable presentation to the client application, the client application sending the third request to the digital wallet application via the wallet connect session.

17. The system of claim 14, wherein the at least one memory further comprises instructions that, when executed by the at least one processor, further cause the system to:
receive, from the client application based on a redirect from the resource system, a third request to access the first application;
determine that the third request does not correspond to a valid session;
in response to determining that the third request does not correspond to a valid session, send a verification link to the client application;
receive, from a trusted issuer system, an indication that registration is complete; and
in response to receiving the indication, redirect the client application to the resource system.

18. The system of claim 17, wherein the at least one memory further comprises instructions that, when executed by the at least one processor, further cause the system to:
receive, from the client application prior to receiving the indication, a fourth request corresponding to the verification link; and
redirect the client application to the trusted issuer system, wherein the indication indicates that the trusted issuer system has provided a verifiable credential to a digital wallet application associated with the client application.

19. The system of claim 14, wherein the wallet connect session allows the first application to send the digital wallet application a third request to approve a blockchain transaction requested by the client application.

20. The system of claim 14, wherein the client application stores the first data in a secure browser storage corresponding to a first domain of the first application, and the at least one memory further comprises instructions that, when executed by the at least one processor, further cause the system to:
prior to receiving the second request, receive the first data from the client application, the client application sending the first data from a second secure browser storage corresponding to a second domain different from the first domain.
